(19) United States
(12) Patent Application Publication
(10) Pub. No.: US 2024/0147993 A1
(43) Pub. Date: May 9, 2024

(54) ACRYLIC COPOLYMER AGRICULTURE FORMULATIONS

(71) Applicants: Dow Global Technologies LLC, Midland, MI (US); Rohm and Haas Company, Collegeville, PA (US)

(72) Inventors: Caroline Woelfle-Gupta, Midland, MI (US); Diana Marcela Vasquez Gutierrez, Lake Jackson, TX (US); Scott T. Wills, Yardley, PA (US); Caroline Nimako-Boateng, Reading, PA (US); Bolatito Ajayi, West Norriton, PA (US)

(21) Appl. No.: 18/549,432

(22) PCT Filed: May 12, 2022
(86) PCT No.: PCT/US2022/028923

§ 371 Date: Sep. 7, 2023

Related U.S. Application Data
(63) Continuation of application No. 63/192,654, filed on May 25, 2021.

(51) Int. Cl. A01N 37/34; A01N 25/04; A01N 25/24; A01N 43/70; A01P 3/00; A01P 13/00

(52) U.S. Cl. CPC A01N 37/34; A01N 25/04; A01N 25/24; A01N 43/70; A01P 3/00; A01P 13/00

(57) ABSTRACT

An agricultural formulation includes a copolymer including (i) 20 wt % to 50 wt % monomeric structural units derived from a first acrylic monomer with a log Kow of 1.0 or less based on a total weight of the copolymer and (ii) from 50 wt % to 80 wt % of monomeric structural units derived from a second acrylic monomer with a log Kow of from 2.0 to 6.0 based on a total weight of the copolymer. The agricultural formulation also includes an active ingredient with a log Kow of greater than 1.0.

### BACKGROUND

### Field of Disclosure

The present disclosure is generally related to agricultural formulations, and more specifically to agricultural formulations including an acrylic copolymer.

### Introduction

Agricultural formulations comprising active ingredients (e.g., pesticides, insecticides, fertilizers, herbicides, etc.) used in crop applications are traditionally sprayed on the tissues of the crops. Water in the form of rain and irrigation may wash the active ingredients off of the crop tissues thereby contaminating waterways while also depriving the crops of the intended active ingredient. The ability of a formulation to retain the active ingredient on the crop tissues is referred to as rainfastness. The ability of a formulation to provide rainfastness often depends on the Log octanol/water partition coefficient (“log Kow”) of the active ingredient. Not all formulations are able to provide suitable rainfastness as even active ingredients having log Kow of greater than 1 (i.e., hydrophobic) are still subject to being washed away by small amounts of water. A formulation may be considered to provide successful rainfastness for the above noted active ingredients if the formulation can retain 80% or greater of the active ingredient on a simulated leaf after five minutes of simulated rainfall (“Successful Rainfastness”).

Agricultural formulations typically include humectants (e.g., polyethylene glycol), spreaders and stickers, rheology modifiers, rainfastness additives, nutrients and multiple other adjuvants leading to complicated formulations. One material that has been tried in the formation of agricultural formulations is acrylic polymers. For example, United States Patent Application Publication number 20180360045A1 discloses a pesticide formulation that achieves enhanced rainfastness performance using an acrylic-based latex. Similarly, European Patent number 2793573B1 discloses pesticide compositions utilizing latex emulsions of hydrophobically modified acrylate containing polymers that exhibit enhanced deposition properties. As demonstrated by the prior art, acrylic polymers are often added to agricultural formulations as an emulsion of the polymer due to the ease of combining a liquid emulsion with other liquids and because acrylic polymers are often formed using emulsion polymerization.

Despite the work done to implement acrylic polymers into pesticide formulations, challenges still exist. For example, acrylic polymer emulsions suffer from instability brought on by the addition of other additives/adjuvants, water and/or active ingredients. Emulsion instability and subsequent flocculation in the formulation may lead to poor shelf life of the formulation and non-uniform distribution on crop tissues. These challenges affect the ability of a composition comprising the acrylic polymer to achieve Successful Rainfastness.

In view of the afore mentioned challenges, it would be surprising to discover an agricultural formulation comprising an acrylic polymer that exhibits Successful Rainfastness and is not subject to flocculation or instability.

### SUMMARY

The inventors of the present invention have discovered an agricultural formulation comprising an acrylic copolymer that exhibits Successful Rainfastness and is not subject to flocculation or instability.

The inventors of the present application have discovered that agricultural formulations utilizing a copolymer comprising 20 wt % to 50 wt % monomeric structural units derived from a first acrylic monomer with a log Kow of 1.0 or less and from 50 wt % to 80 wt % of monomeric structural units derived from a second acrylic monomer with a log Kow of from 2.0 to 6.0 are able to achieve Successful Rainfastness for active ingredients with a log Kow of greater than 1.0. In addition to imparting Successful Rainfastness for active ingredients with a log Kow of greater than 1.0, the incorporation of 20 wt % to 50 wt % monomeric structural units derived from a first acrylic monomer with a log Kow of 1.0 or less enables the copolymer to be water-soluble. The water-soluble nature of the copolymer means that the copolymer does not need to be in an emulsion and thus the risks of flocculation and instability are eliminated, and shelf life stability can be increased.

The present invention is particularly useful for use in agriculture.

According to a first aspect of the present disclosure, an agricultural formulation, comprises a copolymer comprising: (i) 20 wt % to 50 wt % monomeric structural units derived from a first acrylic monomer with a log Kow of 1.0 or less based on a total weight of the copolymer, and (ii) from 50 wt % to 80 wt % of monomeric structural units derived from a second acrylic monomer with a log Kow of from 2.0 to 6.0 based on a total weight of the
copolymer; and an active ingredient with a log Kow of greater than 1.0.

According to a second aspect of the present disclosure, the agricultural formulation comprises from 0.5 wt % to 4.0 wt % of the copolymer based on a total weight of the agricultural formulation.

According to a third aspect of the present disclosure, the agricultural formulation further comprises from 0.5 wt % to 3.0 wt % of a glycol.

According to a fourth aspect of the present disclosure, the active ingredient is a pesticide having a log Kow of 2.5 or greater.

According to a fifth aspect of the present disclosure, the copolymer is a random copolymer of the first and second acrylic monomers and has a weight average molecular weight from 15,000 daltons to 30,000 daltons as measured according to Gel Permeation Chromatography.

According to a sixth aspect of the present disclosure, the first acrylic monomer is methacrylic acid.

According to a seventh aspect of the present disclosure the second acrylic monomer has a log Kow of from 2.0 to 3.0.

According to an eighth aspect of the present disclosure, the second acrylic monomer is butyl methacrylate.

According to a ninth aspect of the present disclosure, the copolymer comprises 60 wt % to 70 wt % of monomeric structural units derived from butyl methacrylate and 30 wt % to 40 wt % of monomeric structural units derived from methacrylic acid based on a total weight of the copolymer.

According to a tenth aspect of the present disclosure, an agricultural mixture comprises water and the agricultural formulation.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, a “wt %” or “weight percent” or “percent by weight” of a component, unless specifically stated to the contrary, is based on the total weight of the composition or article in which the component is included. As used herein, all percentages are by weight unless indicated otherwise.

### Agricultural Formulation

The present disclosure is directed to an agricultural formulation. The agricultural formulation comprises a copolymer and an active ingredient. The agricultural formulation may also comprise one or more glycols and water.

### Copolymer

As explained above, the agricultural formulation comprises the copolymer. As used herein a “copolymer” has two or more of the same or different monomeric structural units derived from two or more different monomers. “Monomeric structural unit”, as used herein in reference to copolymers, indicates a portion of the copolymer structure that results from a reaction of a monomer or monomers to form the copolymer. “Different” in reference to monomeric structural units indicates that the monomeric structural units differ from each other by at least one atom or are different isomerically. Embodiments of the present disclosure provide that the monomeric structural units of the copolymer result, i.e. are formed, from a polymerization reaction of the monomers. The copolymer may be either a random copolymer (i.e. the ordering of monomer polymerization is random), a block copolymer (i.e., the copolymer contains alternating sections of a single monomer type) or contain both block copolymer and random portions. A monomeric structural unit may undergo one or more reactions subsequent to the polymerization reaction, e.g., a hydrolysis reaction.

The copolymer comprises monomeric structural units derived from a first acrylic monomer. As used herein, an “acrylic monomer” is a monomer comprising an acrylic acid moiety or a salt, ester, and/or conjugate base of the acrylic acid moiety. The copolymer comprises 20 wt % to 50 wt % monomeric structural units derived from the first acrylic monomer based on the total weight of the copolymer. For example, the copolymer comprises 20 wt % or greater, or 25 wt % or greater, or 30 wt % or greater, or 35 wt % or greater, or 40 wt % or greater, or 45 wt % or greater, while at the same time, 50 wt % or less, or 45 wt % or less, or 40 wt % or less, or 35 wt % or less, or 30 wt % or less, or 25 wt % or less of the first acrylic monomer based on the total weight of the copolymer.

The first acrylic monomer has a log Kow of 1.0 or less as determined by Kow Testing as explained in greater detail below. The first acrylic monomer has a log Kow of 1.0 or less, or 0.95 or less, or 0.90 or less, or 0.85 or less, or 0.80 or less, or 0.75 or less, or 0.70 or less, or 0.65 or less, or 0.60 or less, or 0.55 or less, or 0.50 or less, or 0.45 or less, or 0.40 or less, or 0.35 or less, or 0.30 or less, or 0.25 or less, while at the same time, 0.20 or greater, or 0.25 or greater, or 0.30 or greater, or 0.35 or greater, or 0.40 or greater, or 0.45 or greater, or 0.50 or greater, or 0.55 or greater, or 0.60 or greater, or 0.65 or greater, or 0.70 or greater, or 0.75 or greater, or 0.80 or greater, or 0.85 or greater, or 0.90 or greater, or 0.95 or greater. Examples of suitable monomers for use as the first acrylic monomer include methacrylic acid (log Kow of 0.93), acrylic acid (log Kow of 0.35), methyl acrylate (log Kow of 0.73) and/or combinations thereof.

The copolymer comprises monomeric structural units derived from a second acrylic monomer. The copolymer comprises 50 wt % to 80 wt % of monomeric structural units derived from a second acrylic monomer based on a total weight of the copolymer. For example, the copolymer comprises 50 wt % or greater, or 55 wt % or greater, or 60 wt % or greater, or 65 wt % or greater, or 70 wt % or greater, or 75 wt % or greater, while at the same time, 80 wt % or less, or 75 wt % or less, or 70 wt % or less, or 65 wt % or less, or 60 wt % or less, or 55 wt % or less of monomeric structural units derived from the second acrylic monomer based on a total weight of the copolymer.

The second acrylic monomer has a log Kow of 2.0 to 6.0 determined by Kow Testing. For example, the second acrylic monomer has a log Kow of 2.0 or greater, or 2.2 or greater, or 2.4 or greater, or 2.6 or greater, or 2.8 or greater, or 3.0 or greater, or 3.2 or greater, or 3.4 or greater, or 3.6 or greater, or 3.8 or greater, or 4.0 or greater, or 4.2 or greater, or 4.4 or greater, or 4.6 or greater, or 4.8 or greater, or 5.0 or greater, or 5.2 or greater, or 5.4 or greater, or 5.6 or greater, or 5.8 or greater, while at the same time, 6.0 or less, or 5.8 or less, or 5.6 or less, or 5.4 or less, or 5.2 or less, or 5.0 or less, or 4.8 or less, or 4.6 or less, or 4.4 or less, or 4.2 or less, or 4.0 or less, or 3.8 or less, or 3.6 or less, or 3.4 or less, or 3.2 or less, or 3.0 or less, or 2.8 or less, or 2.6 or less, or 2.4 or less, or 2.2 or less. Exemplary second acrylic monomers for use in the copolymer include, but are not limited to, butyl methacrylate (log P of 2.75), butyl acrylate (log P of 2.20), 2-ethylehexyl acrylate (log P of 4.09) and/or combinations thereof.

The agricultural formulation may comprise from 0.5 wt % to 4.0 wt % of the copolymer based on a total weight of the agricultural formulation. For example, the agricultural formulation comprises 0.5 wt % or greater, or 1.0 wt % or greater, or 1.5 wt % or greater, or 2.0 wt % or greater, or 2.5 wt % or greater, or 3.0 wt % or greater, or 3.5 wt % or greater, while at the same time, 4.0 wt % or less, or 3.5 wt % or less, or 3.0 wt % or less, or 2.5 wt % or less, or 2.0 wt % or less, or 1.5 wt % or less, or 1.0 wt % or less of the copolymer based on the total weight of the agricultural formulation.

The copolymer has a weight average molecular weight from 15,000 daltons to 30,000 daltons. For example, the copolymer may have a weight average molecular weight of 15,000 daltons or greater, or 16,000 daltons or greater, or 17,000 daltons or greater, or 18,000 daltons or greater, or 19,000 daltons or greater, or 20,000 daltons or greater, or 21,000 daltons or greater, or 22,000 daltons or greater, or 23,000 daltons or greater, or 24,000 daltons or greater, or 25,000 daltons or greater, or 26,000 daltons or greater, or 27,000 daltons or greater, or 28,000 daltons or greater, or 29,000 daltons or greater, while at the same time, 30,000 daltons or less, or 29,000 daltons or less, or 28,000 daltons or less, or 27,000 daltons or less, or 26,000 daltons or less, or 25,000 daltons or less, or 24,000 daltons or less, or 23.000 daltons or less, or 22,000 daltons or less, or 21,000 daltons or less, or 20,000 daltons or less, or 19,000 daltons or less, or 18,000 daltons or less, or 17,000 daltons or less, or 16,000 daltons or less. The weight average molecular weight of the copolymer is determined using gel permeation chromatography and is measured by gel permeation chromatography (GPC) against a poly(methylmethacrylate) standard.

The copolymer can be prepared by solution polymerization. The solution polymerization of monomers can be performed in a non-aqueous solvent, for instance. Suitable solvents include, but are not limited to, toluene, xylenes, propylene glycol, methylethylketone, and combinations thereof. The solution polymerization can include a solvent-soluble initiator. Examples of the initiator include, but are not limited to, t-butylperoctoate, t-butylhydroperoxide, AIBN, 2,2-azobis(2,4-dimethyl-pentanenitrile), t-butylperoxybenzoate, and combinations thereof. The initiator may be used from 0.01 wt % to 1.00 wt %, based on a total weight of monomers utilized in the solution polymerization, for instance.

The copolymer can be prepared by emulsion polymerization. The emulsion polymerization may utilize a surfactant such as anionic surfactants such as sodium lauryl sulfate, sodium dodecylbenzenesulfonate, and sodium ethoxylated[C₁₀] alcohol half-ester of sulfosuccinic acid, and/or combinations thereof. The surfactant may be used from 0.5 wt % to 6.0 wt %, based on a total weight of monomers utilized in the emulsion polymerization, for instance. The emulsion polymerization may utilize an initiator, such as a water-soluble initiator, for instance. Examples of initiators include, but are not limited to, alkali metal persulfates, ammonium persulfate, and combinations thereof. The initiator may be utilized from 0.01 wt % to 1.00 wt %, based on a total weight of monomers utilized in the emulsion polymerization. The emulsion polymerization may utilize a chain transfer mercaptan. Examples of chain transfer mercaptans include, but are not limited to, 2-mercaptopropionic acid, 3-methylmercaptopropionic acid, alkyl mercaptans containing from 4 to 20 carbon atoms, and combinations thereof. The chain transfer mercaptan may be utilized from 0.01 wt % to 5.00 wt % based on a total weight of monomers utilized in the emulsion polymerization. The use of mercaptan modifier may reduce the molecular weight of the polymer. Other known components may be utilized for the emulsion polymerization; different amount of these other known components may be utilized for various applications.

The monomeric structural units of the copolymer may undergo one or more reactions subsequent to the polymerization reaction, e.g., a hydrolysis reaction. The hydrolysis reaction can include the hydrolysis of an ester to an acid or the ring-opening of an anhydride to an acid, for example.

The copolymer is available from The Dow Chemical Company, Midland, Michigan.

### Active Ingredient

The agricultural formulation comprises an active ingredient. The active ingredient has a log Kow of greater than 1.0 as determined according to Kow Testing. For example, the active ingredient can have a log Kow of 1.1 or greater, or 1.2 or greater, or 1.4 or greater, or 1.6 or greater, or 1.8 or greater, or 2.0 or greater, or 2.2 or greater, or 2.4 or greater, or 2.6 or greater, or 2.8 or greater, or 3.0 or greater, or 3.2 or greater, or 3.4 or greater, or 3.6 or greater, or 3.8 or greater, or 4.0 or greater, or 4.2 or greater, or 4.4 or greater, or 4.6 or greater, or 4.8 or greater, or 5.0 or greater, or 5.2 or greater, or 5.4 or greater, or 5.6 or greater, or 5.8 or greater, while at the same time, 6.0 or less, or 5.8 or less, or 5.6 or less, or 5.4 or less, or 5.2 or less, or 5.0 or less, or 4.8 or less, or 4.6 or less, or 4.4 or less, or 4.2 or less, or 4.0 or less, or 3.8 or less, or 3.6 or less, or 3.4 or less, or 3.2 or less, or 3.0 or less, or 2.8 or less, or 2.6 or less, or 2.4 or less, or 2.2 or less, or 2.0 or less, or 1.8 or less, or 1.6 or less, or 1.4 or less, or 1.2 or less. Exemplary active ingredients include, but are not limited to, atrazine, chlorothalonil, diuron, terbuthylazine, abamectin, azinphos-methyl, bifenthrin, chlorpyrifos, clofentezine, endosulfan, bupirimate, captan, folpet, tebuconazole, novaluron, tau-fluvalinate, bifenthrin, chlorpyrifos, lambda cyhalothrin, bifenthrin, chlorpyrifos, metallic copper, endosulfan, and combinations thereof.

The agricultural formulation may comprise from 30 wt % to 99 wt % of the active ingredient based on a total weight of the agricultural formulation. For example, the agricultural formulation comprises 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, or 80 wt % or greater, or 85 wt % or greater, or 90 wt % or greater, or 95 wt % or greater, or 98 wt % or greater, while at the same time, 99 wt % or less, or 95 wt % or less, or 90 wt % or less, or 85 wt % or less, or 80 wt % or less, or 75 wt % or less, or 70 wt % or less, or 65 wt % or less, or 60 wt % or less, or 55 wt % or less, or 50 wt % or less, or 45 wt % or less, or 40 wt % or less, or 35 wt % or less of the active ingredient based on the total weight of the agricultural formulation.

### Glycol.

The agricultural formulation may comprise one or more glycols. For example, the agricultural formulation may comprise ethylene glycol, propylene glycol, butylene glycol, higher order glycols and/or combinations thereof. The agricultural formulation may comprise 0.5 wt % or greater, or 1.0 wt % or greater, or 1.5 wt % or greater, or 2.0 wt % or greater, or 2.5 wt % or greater, while at the same time, 3.0 wt % or less, or 2.5 wt % or less, or 2.0 wt % or less, or 1.5 wt % or less, or 1.0 wt % or less of the glycol based on the total weight of the agricultural formulation.

### Agricultural Mixture

The agricultural formulation may be diluted with one or more solvents or liquids to produce an agricultural mixture. For example, the agricultural formulation may be diluted in water to form the agricultural mixture. In such a scenario, the agricultural formulation may be known as an “in-can mixture” that is diluted with additional water to form the agricultural mixture which is distributed on a field containing crops. The agricultural mixture may comprise 0.5 wt % or greater, or 1.0 wt % or greater, or 5 wt % or greater, or 10 wt % or greater, or 15 wt % or greater, or 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, or 80 wt % or greater, or 85 wt % or greater while at the same time, 90 wt % or less, or 85 wt % or less, or 80 wt % or less, or 75 wt % or less, or 70 wt % or less, or 65 wt % or less, or 60 wt % or less, or 55 wt % or less, or 50 wt % or less, or 45 wt % or less, or 40 wt % or less, or 35 wt % or less, or 30 wt % or less, or 25 wt % or less, or 20 wt % or less, or 15 wt % or less, or 10 wt % or less, or 5 wt % or less of the agricultural formulation based on the total weight of the agricultural mixture.

### EXAMPLES

### Materials

The following materials were used in the formation and testing of the examples.

Atrazine is an atrazine (log Kow 2.61) based weed killer commercially available as Hi-atrazine weed killer from Voluntary Purchasing Group, Bonham, Texas.

Chlorothalonil is a chlorothalonil (log Kow 2.88) based weed killer and is commercially available as Chlorothalonil 720 from Drexel Chemical, Memphis, Tennessee.

Copolymer was formed using solution polymerization to form a random copolymer having approximately 60 wt % to 70 wt % of monomeric structural units derived from butyl methacrylate and approximately 30 wt % to 40 wt % of monomeric structural units derived from methacrylic acid based on a total weight of the copolymer. The copolymer was neutralized using ammonia to form an ammonia salt of an acrylic copolymer and had a weight average molecular weight of approximately 27,000 daltons as measured according to GPC. The copolymer is available from The Dow Chemical Company, Midland, Michigan.

Pinene is a pinene-based rainfastness adjuvant comprising diterpenes polymers, hydrocarbon resin, petrolatum, a-(p-dodecylphenyl)-omega-hydroxpoly (oxyethylene) and is commercially available as Nu-Film 17™ from Miller Chemical and Fertilizer Corporation, Hanover, Pennsylvania.

Propylene glycol is a solvent diol and is available from The Dow Chemical Company, Midland, Michigan.

### Sample Preparation

Samples were prepared by weighing all the components (except water) separately, then combining the two materials in a vial, and vortex mixing for 2800 revolutions per minutes for 30 seconds. The resulting formulations were then diluted to a dilution rate tailored to the active ingredient used, as listed in Table 1. Water was used as the diluent.

TABLE 1

| | Atrazine | Chlorothalonil | Copolymer | Pinene | Water | Propylene glycol | Dilution rate |
|---|---|---|---|---|---|---|---|
| Ex. | (wt %) | (wt %) | (wt %) | (wt %) | (wt %) | (%) | (mL/100 mL) |
| IE1 | 97 | 0 | 1.12 | 0 | 1.09 | 0.79 | 1.3 |
| IE2 | 93 | 0 | 2.61 | 0 | 2.55 | 1.84 | 1.3 |
| IE3 | 0 | 97 | 1.12 | 0 | 1.09 | 0.79 | 1 |
| IE4 | 0 | 93 | 2.61 | 0 | 2.55 | 1.84 | 1 |
| CE1 | 100 | 0 | 0 | 0 | 0 | 0 | 1.3 |
| CE2 | 93 | 0 | 0 | 7 | 0 | 0 | 1.3 |
| CE3 | 0 | 100 | 0 | 0 | 0 | 0 | 1 |
| CE4 | 0 | 97 | 0 | 3 | 0 | 0 | 1 |
| CE5 | 0 | 93 | 0 | 7 | 0 | 0 | 1 |

### Test Method

Kow Testing: The log Kow values of the first and second acrylic monomers and the active ingredients are determined by utilizing the Estimation Programs Interface (EPI) Suite™, (KOWWIN version 1.68) available at https://www.epa.gov/tsca-screening-tools/epi-suitetm-estimation-program-interface.

Rainfastness testing: Three replicates per sample were used to calculate the mean performance and standard deviation. Formulations were prepared with the desired rainfastness adjuvant at a desired concentration and once the formulations were made, they were further diluted based on an average dilution rate determined from the label of each active ingredient. A control was included in the experiments that was free of the pinene and copolymer. A 2″×4″ piece of Parafilm® sheet (i.e., used to mimic plant leaves) was cut and placed on a black Leneta card. The Parafilm® sheet was carefully wiped with a Kimwipe® cloth before performing the experiments. Using an auto-pipette, 15×30 μL drops of the prepared formulations were dropped onto the Parafilm® following a 3 rows×5 columns pattern. The formulations were vortex-mixed after depositing each set of five drops to ensure the formulations were kept homogenous and that the composition of each drop was the same. The resulting samples were then stacked into a container and placed in a hood overnight. Once the samples were fully dried, they were exposed to simulated rain using an Exo Terra Monsoon RS400 Rainfall System™ rain simulator fitted with 2 Exo Terra standard nozzles without any extensions for the indicted amount of time. The samples were placed at a distance of 33 centimeters from the nozzle and the spray flow rate was 6 liters per hour. Once dried, the Parafilm® sheet was cut into fifteen individual sections and further analyzed with the Atrazine test method and Chlorothalonil test method explained below.

Atrazine test method: An ultra-high-performance liquid chromatograph coupled with an ultraviolet detector was used to determine the concentration of atrazine present on the Parafilm® sheet before and after exposure to simulated rain. Each of Parafilm® sheet sections was added to a separate glass vial with 15 grams of methanol. The samples were shaken at least 30 minutes on a horizontal shaker, and 1 milliliters (“mL”) of each solvent was transferred to autosampler vials. The samples were quantitated using an isocratic flow profile (i.e., 40:60 water:methanol, 0.05% formic acid, 0.4 mL/minute) on a 2.1 millimeter (“mm”)×50 mm C18 ultra-high-performance liquid chromatograph column, and UV detection (222 nanometer) with reference to an atrazine calibration curve.

Chlorothalonil test method: An ultra-high-performance liquid chromatograph coupled with an ultraviolet detector was used to determine the concentration of chlorothalonil present on the Parafilm® sheet before and after exposure to simulated rain. Each of Parafilm® sheet sections was added to a separate glass vial with 15 g of acetone. The samples were shaken at least 30 minutes on a horizontal shaker, and 1 mL of each solvent was transferred to autosampler vials. The samples were quantitated using an isocratic flow profile (i.e., 40:60 water:methanol, 0.05% formic acid, 0.4 mL/min) on a 2.1×50 mm C18 ultra-high-performance liquid chromatograph column, and UV detection (222 nanometers) with reference to a chlorothalonil calibration curve.

### Results

Referring now to Table 2, provided are the results of the Atrazine test method and the Chlorothalonil test method after Rainfastness Testing was performed for various amounts of time.

TABLE 2

| | | Atrazine | Chlorothalonil | Standard |
|---|---|---|---|---|
| | Time | Retention | Retention | deviation |
| Ex. | (Minutes) | (%) | (%) | (%) |
| IE1 | 5 | 83.39 | N/A | 3.51 |
| IE1 | 10 | 62.60 | N/A | 3.51 |
| IE1 | 30 | 80.29 | N/A | 3.51 |
| IE2 | 5 | 94.40 | N/A | 3.51 |
| IE2 | 10 | 87.03 | N/A | 3.51 |
| IE2 | 30 | 82.06 | N/A | 3.51 |
| CE1 | 5 | 6.09 | N/A | 3.51 |
| CE1 | 10 | 6.08 | N/A | 3.51 |
| CE1 | 30 | 0.88 | N/A | 3.51 |
| CE2 | 5 | 41.18 | N/A | 3.51 |
| IE3 | 5 | N/A | 85.59 | 2.56 |
| IE3 | 10 | N/A | 50.40 | 2.56 |
| IE3 | 30 | N/A | 62.36 | 2.56 |
| IE4 | 5 | N/A | 98.04 | 2.56 |
| IE4 | 10 | N/A | 95.74 | 2.56 |
| IE4 | 30 | N/A | 92.24 | 2.56 |
| CE3 | 5 | N/A | 45.91 | 2.56 |
| CE3 | 10 | N/A | 49.53 | 2.56 |
| CE3 | 30 | N/A | 44.10 | 2.56 |
| CE4 | 5 | N/A | 61.51 | 2.56 |
| CE4 | 10 | N/A | 55.16 | 2.56 |
| CE4 | 30 | N/A | 57.95 | 2.56 |
| CE5 | 5 | N/A | 56.43 | 2.56 |
| CE5 | 10 | N/A | 61.27 | 2.56 |
| CE5 | 30 | N/A | 66.00 | 2.56 |

As self-evident from Table 2, the incorporation of the copolymer into the agricultural formulation dramatically increases the retention of both atrazine and chlorothalonil retention as compared to the comparative examples and is able to achieve Successful Rainfastness. CE1 demonstrates that lack of a rainfastness agent in the agricultural formulation results in unacceptably low atrazine retention regardless of rainfall exposure time. Incorporation of the pinene rainfastness additive in CE2 demonstrates that even with a rainfastness adjuvant, the atrazine retention is unacceptably low at about 41% after only 5 minutes. Contrary to CE1 and CE2, IE1 and IE2 including the copolymer are both able to achieve Successful Rainfastness by demonstrating 80% or greater atrazine retention after 5 minutes of simulated rainfall. In fact, TEl and IE2 are both able to demonstrate 80% or greater atrazine retention after 30 minutes of simulated rainfall thus far surpassing Successful Rainfastness parameters.

With respect to IE3, IE4 and CE3-CE5, it is clear that the use of the copolymer into the agricultural formulation provides Successful Rainfastness. As can be seen, the addition of the copolymer at concentrations as low as 1.1 wt % (i.e., IE3) is able to achieve Successful Rainfastness. IE4 demonstrates that an increased copolymer concentration of about 2.6 wt % allows the agricultural formulation to retain greater than 90% of the chlorothalonil even after 30 minutes of simulated rainfall. In contrast, none of CE3-CE5 are able to achieve Successful Rainfastness. CE3, having no rainfastness adjuvant, demonstrates that chlorothalonil easily washes off under the simulated rainfall. CE3 and CE4 demonstrate that while increasing amounts of the pinene rainfastness adjuvant increase the chlorothalonil retention, it is still insufficient to achieve Successful Rainfastness. Despite similar loadings of the copolymer and pinene, IE3 and IE4 are able to achieve Successful Rainfastness while CE4 and CE5 are not demonstrating the effectiveness of the copolymer in retaining active ingredients having a log Kow of 1 or greater.

1. An agricultural formulation, comprising:
a copolymer comprising:
(i) 20 wt % to 50 wt % monomeric structural units derived from a first acrylic monomer with a log Kow of 1.0 or less based on a total weight of the copolymer, and
(ii) from 50 wt % to 80 wt % of monomeric structural units derived from a second acrylic monomer with a log Kow of from 2.0 to 6.0 based on a total weight of the copolymer; and
an active ingredient with a log Kow of greater than 1.0.

2. The agricultural formulation of claim 1, wherein the agricultural formulation comprises from 0.5 wt % to 4.0 wt % of the copolymer based on a total weight of the agricultural formulation.

3. The agricultural formulation of claim 1, further comprising:
from 0.5 wt % to 3.0 wt % of a glycol.

4. The agricultural formulation of claim 1, wherein the active ingredient is a pesticide having a log Kow of 2.5 or greater.

5. The agricultural formulation of claim 1, wherein the copolymer is a random copolymer of the first and second acrylic monomers and has a weight average molecular weight from 15,000 daltons to 30,000 daltons as measured according to Gel Permeation Chromatography.

6. The agricultural formulation of claim 1, wherein the first acrylic monomer is methacrylic acid.

7. The agricultural formulation of claim 6, wherein the second acrylic monomer has a log Kow of from 2.0 to 3.0.

8. The agricultural formulation of claim 1, wherein the second acrylic monomer is butyl methacrylate.

9. The agricultural formulation of claim 1, wherein the copolymer comprises 60 wt % to 70 wt % of monomeric structural units derived from butyl methacrylate and 30 wt % to 40 wt % of monomeric structural units derived from methacrylic acid based on a total weight of the copolymer.

10. An agricultural mixture comprising:
water; and
the agricultural formulation of claim 1.
